(19) United States
(12) Patent Application Publication
(10) Pub. No.: US 2006/0142053 A1
(43) Pub. Date: Jun. 29, 2006

(54) Method and system for incorporating a lens in a clam shaped housing

(75) Inventors: Jorge L. Garcia, Plantation, FL (US); Habib Amirzadeh, Weston, FL (US); Raymond P. Meenen, Boca Raton, FL (US); Thomas J. Pack, Boca Raton, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/012,652

(22) Filed: Dec. 15, 2004

(51) Int. Cl. H04M 1/00

(52) U.S. Cl. 455/556.1; 455/575.3

(57) ABSTRACT

A communication device (10) in a clam shaped housing includes a camera (12) incorporated within a first portion (18) of the clam-shaped housing and a lens (14) incorporated within a second portion (19) of the clam-shaped housing. The camera and the lens can substantially align when the first portion pivots relative to the second portion. The lens can be an afocal converter lens that changes an effective focal length of a lens of the camera from among a wide angle, a telephoto, and a macro lens. The communication device can have at least one among a main display (15) on a flip portion of the communication device or an auxiliary display (16) on an opposing side (21) to enable viewing without the lens when the communication device is an open position and the auxiliary display can enable viewing with the lens when the communication device is in a closed position.

### FIELD OF THE INVENTION

This invention relates generally to lens attachments, and more particularly to a method and system for applying a lens or filter to a camera in a communication product.

### BACKGROUND OF THE INVENTION

Most cameras lenses have a fairly narrow field of view. Most lenses are designed to minimize distortion at the expense of a narrow angle. The narrow angle then typically requires the user to be at a larger distance from an object in order to take a picture of a wide scene. When a user cannot step back to take a wide angle scene (such as in a small room), a wide angle lens can be attached to the front of the camera. Attaching a wide angle lens to a camera is often cumbersome since the attachment lens is a separate attachment which can be misplaced or defective. Cell phones are often used to take pictures in confined environments and no known existing communication device having an integrated camera has a convenient means for providing attachments that can alter the focal length, field of view, lighting, or filtering for the integrated camera.

### SUMMARY OF THE INVENTION

Embodiments in accordance with the present invention can incorporate a wide angle lens, a macro lens, a telephoto lens, a light shade or light filter into the flip of a communication product such as a cell phone. Such incorporation can obviate the use of a separate lens attachment.

In a first embodiment of the present invention, a camera phone in a flip style housing can include a camera incorporated within a first portion of the flip style housing of the camera phone and a lens incorporated within a second portion of the flip style housing of the camera phone. The camera can align substantially with the lens when the first portion pivots relative to the second portion. The lens can be a converter lens that changes the focal length of the camera from among a wide angle lens, a telephoto lens, and a macro lens, according to the converter lens selected. The lens can alternatively be an attachment that serves as a lens hood or a filter such as an ultraviolet filter. Note, the first portion can be a base of the camera phone and the second portion can be a flip portion of the camera phone. Alternatively, the first portion can be a flip portion of the camera phone while the second portion can be a base of the camera phone. The camera phone can also include at least one display such as a main display on the flip portion or an auxiliary display on an opposing side of the flip portion which enables viewing without the lens when the camera phone is in an open position. Another display or the auxiliary display on the opposing side of the flip portion can enable viewing with the lens when the camera phone is in a closed position. To provide for sufficient tolerance between the camera and the lens, a lens exit pupil can be constructed to be significantly larger than a camera entrance pupil.

In a second embodiment of the present invention, a communication device in a clam shaped housing can include a camera incorporated within a first portion of the clam-shaped housing of the communication device and a lens incorporated within a second portion of the clam-shaped housing of the communication device. The camera and the lens can substantially align when the first portion pivots relative to the second portion. The lens can be an afocal converter lens that changes an effective focal length of a lens of the camera from among a wide angle lens, a telephoto lens, and a macro lens in accordance to the afocal converter lens selected. Note, the first portion can be a base of the communication device and the second portion can be a flip portion of the communication device. Alternatively, the first portion can be a flip portion of the camera phone while the second portion can be a base of the camera phone. The communication device can include at least one display and can also include a keypad on the first portion. In one embodiment, the communication device can have at least one among a main display on a flip portion of the communication device or an auxiliary display on an opposing side of the flip portion to enable viewing without the lens when the communication device is an open position and the auxiliary display on the opposing side of the flip portion can enable viewing with the lens when the communication device is in a closed position.

In a third embodiment, a method of incorporating an attachment lens to a camera in a camera phone in a flip style housing can include the steps of incorporating the camera within a first portion of the flip style housing, incorporating the attachment lens within a second portion of the flip style housing, and selectively aligning the camera with the attachment lens when the first portion pivots relative to the second portion. The attachment lens can be among a wide angle lens, a telephoto lens, a macro lens, and a filter. Note, the camera phone can further include at least one display and the method can further include the step of viewing an image on a main display on a flip portion of the camera phone or on an auxiliary display on an opposing side of the flip portion when the phone is in an open position and viewing another image using the attachment lens on the auxiliary display when the camera phone is in a closed position.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a perspective view of a camera phone in an open position having a camera and a lens in accordance with an embodiment the present invention.

FIG. 2 is another perspective view of the camera phone of FIG. 1 illustrating the lens on an opposing side of a base portion of the camera phone in accordance with an embodiment of the present invention.

FIG. 3 is another perspective view of the camera phone of FIG. 1 in a closed position illustrating an auxiliary display on an opposing side of a flip portion of the camera phone in accordance with an embodiment of the present invention.

FIG. 4 is another perspective view of the camera phone of FIG. 1 in a closed position once again illustrating the lens in accordance with an embodiment of the present invention.

FIG. 5 is a flow chart illustrating a method of incorporating an attachment lens to a camera in a camera phone in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

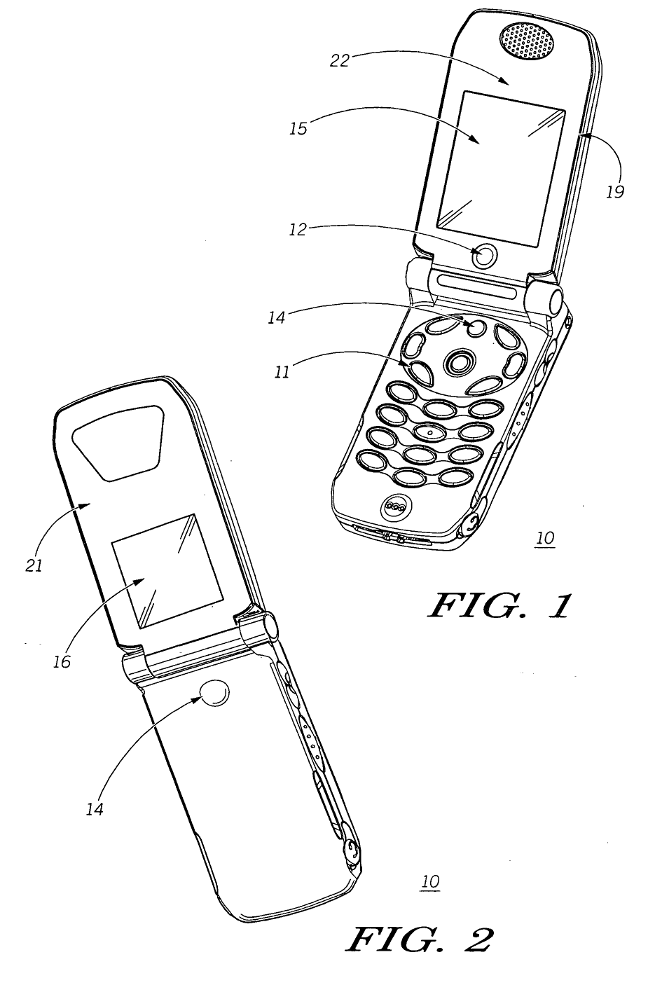

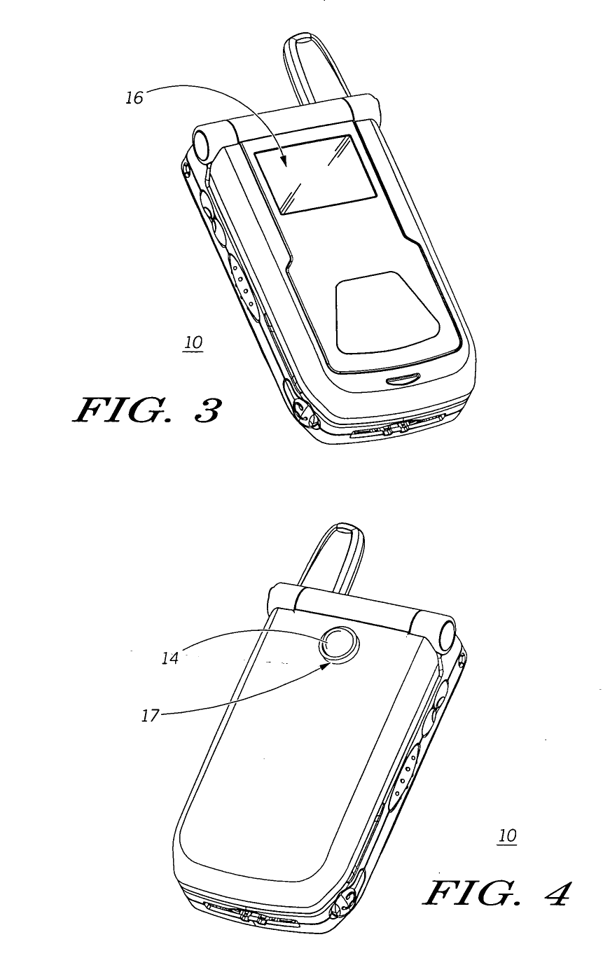

Most phone cameras are of fixed focal length. An additional lens(es) is required to change the focal length so that a wider field of perspective can be taken. In accordance with an embodiment of the invention, changing the focal length can be achieved by incorporating an additional lens on one of the flip sides of a camera phone having a flip style or clam shaped housing. More specifically, referring to FIGS. 1-4, a communication product such as a camera phone 10 can include a camera 12 and a lens 14 that substantially align together when a first portion 18 and a second portion 19 of the camera phone 10 pivot relative to each other. The lens 14 can be a converter lens that changes the focal length of the camera 12 from among a wide angle lens, a telephoto lens, and a macro lens in accordance to the converter lens selected. The lens can alternatively be an attachment that serves as a lens hood 17 (as shown in FIG. 4) or a filter such as an ultraviolet filter. Note, the first portion 18 can be a base of the camera phone 10 and the second portion 19 can be the flip portion of the camera phone 10. The base of the phone can also include a plurality of keys or a keypad 11. Alternatively, the first portion can be a flip portion of the camera phone while the second portion can be a base of the camera phone. The camera phone 10 can also include at least one display such as a main display 15 on a first side 22 of the flip portion (such as the second portion 19) or an auxiliary display 16 an opposing side 21 of the flip portion 19 which enables viewing without the lens 14 when the camera phone 10 is in an open position as shown in FIG. 1 or FIG. 2. For example, opening the flip portion 19 can allow a user to see himself or herself without the use of the wide-angle lens 14 in the main display 15 and the auxiliary display 16 can be viewed for taking pictures away from the user. Another display or the auxiliary display 16 on the opposing side 21 of the flip portion (19) can enable viewing with the lens 14 when the camera phone 10 is in a closed position as shown in FIG. 3. To provide for sufficient tolerance between the camera and the lens, a lens exit pupil can be constructed to be significantly larger than a camera entrance pupil. Note, stops and apertures limit the brightness of an image and the field of view of an optical system and an aperture stop (AS) is defined to be the stop or lens ring, which physically limits the solid angle of rays passing through the system from an on-axis object point. Thus, the exit pupil is the image of the aperture stop formed by the light rays after they have passed through the optical system, i.e. it is the image of the aperture stop as seen through all the optics beyond the aperture stop. It can be a real or virtual image, depending on the location of the aperture stop. The entrance pupil is the opening an observer would identify as the limitation on the solid angle of rays diverging from an on-axis object point, i.e. it is the image of the aperture stop in as seen through all the optics before the aperture stop. Again, it can be a real or virtual image, depending on the location of the aperture stop. In an optical system designed for visual observations, it is desirable to have the exit pupil approximately coincide with the pupil of the observer's eye. This is the origin of the term “pupil”.

Operationally, during a regular picture taking mode as shown in FIG. 1, the flip portion 19 of the camera phone 10 is open. Depending on how the camera 12 is oriented, the auxiliary display 16 (such as an outer LCD display) or the main display 15 or both can be used as a viewfinder. In a wide angle picture taking mode or another alternative mode (depending on nature of the attachment or filter or lens 14 used), the flip portion 19 of the camera phone 10 is closed. The attachment or filter or lens 14 can provide the function of either a wide angle lens, a telephoto lens, a macro lens, a filter such as a UV filter, or a light shade when the lens 14 (or light hood 17) is aligned in front of the camera 12. Note, most converter lenses are afocal, that is they have no focusing power, therefore they can work with many different primary lenses. The converter lens 14 can be mechanically secured to the primary lens of the camera 12 using the pivoting mechanism of the clam shaped housing of the camera phone 10. Since tolerances can be of a concern, a lens exit pupil can be constructed to be significantly larger than a camera entrance pupil as illustrated in FIG. 1. In any event, the incorporated attachment 14 enables quick changes between a default-narrow angle photo system and an alternative photo environment such as a wide angle photo system by simply opening or closing the phone flip. Further note, that a user of such a camera phone can be provided with a kit of lenses to enable them to mechanically secure one or more lens attachments (14) as they might desire. For example, a camera phone can be initially outfitted with a wide angle lens and a user can further add a filter or alternatively replace the wide angle lens with just the filter or another type of lens.

To avoid vignetting over all the field angles of the camera, the aperture of the converter lens 14 can be larger than the primary lens of the camera 12. Note, most wide angle converters are “reverse telephoto”, with a negative lens followed by a positive lens, or combinations thereof where:

Magnification =−F1/F2, where F1 can be the focal length of the positive lens and F2 can be the focal length of the negative lens.

If F1=−F2/2, then M=0.5×

An afocal optical system can be used to provide a robust flip lens design. To provide further proof of concept, an imager placed at the exit pupil of an afocal optical system would maintain a focused spot as an image (or lens) shifts through rays of the same angle. In this regard, afocal systems are somewhat shift invariant.

An aperture is a physical stop in the system. The entrance pupil is the image of the aperture in object space, and the exit pupil is the image of the aperture in image space. The exit pupil of the converter lens 14 can align with the entrance pupil of the camera 12. Vignetting is a clipping of the light bundle due to field angle or misaligned apertures. The camera pupil should be able to shift within the converter pupil through all field angles.

The amplitude and phase of light rays are path dependent through an optical system. These typically degrade away from the center of the optical axis (0,0). Optical path difference plots can show increasing waves of aberration away from the origin and its color dependency. A converter lens 14 should be designed to have slow varying aberrations in the pupil and be color corrected.

If the attachment 14 is a wide angle converter lens, then good imaging can be achieved using an afocal lens that has no focusing power. Angular magnification, of approximately 0.8× to 0.5×, reduces the system focal length, and thus increases field of view. The exit pupil of the converter lens 14 should be coincident with the entrance pupil of the imager of the camera 12. Again, the converter pupil should be larger than the camera pupil to accommodate the expected de-centering tolerance and minimize vignetting. To avoid converter lens aberrations, the lens 14 should be slow varying across the pupil region where shift is expected and should be well color corrected.

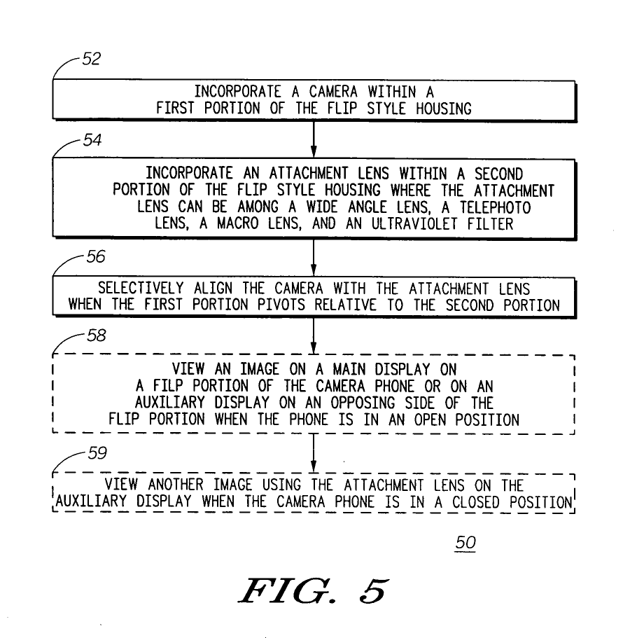

Referring to FIG. 5, a method 50 of incorporating an attachment lens to a camera in a camera phone in a flip style housing can include the step 52 of incorporating the camera within a first portion of the flip style housing and the step 54 of incorporating the attachment lens within a second portion of the flip style housing. The attachment lens can be among a wide angle lens, a telephoto lens, a macro lens, and an ultraviolet filter. At step 56, the method 50 can include selectively aligning the camera with the attachment lens when the first portion pivots relative to the second portion. At step 58, an image can be viewed on a main display on a flip portion of the camera phone or on an auxiliary display on an opposing side of the flip portion when the phone is in an open position. At step 59, another image can be viewed on the auxiliary display using the attachment lens when the camera phone is in a closed position.

In light of the foregoing description, it should be recognized that embodiments in accordance with the present invention can be realized in hardware, software, or a combination of hardware and software. In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A camera phone in a flip style housing, comprising:
a camera incorporated within a first portion of the flip style housing of the camera phone; and
a lens incorporated within a second portion of the flip style housing of the camera phone, wherein the camera substantially aligns with the lens when the first portion pivots relative to the second portion.

2. The camera phone of claim 1, wherein the lens changes the focal length of the camera.

3. The camera phone of claim 1, wherein the lens is selected among a wide angle lens, a telephoto lens, a macro lens, a lens hood, and a filter.

4. The camera phone of claim 1, wherein the lens is a converter lens that changes an effective focal length of a lens of the camera from among a wide angle lens, a telephoto lens, and a macro lens, according to the converter lens selected.

5. The camera phone of claim 1, wherein the first portion is a base of the camera phone and the second portion is a flip portion of the camera phone.

6. The camera phone of claim 1, wherein the first portion is a flip portion of the camera phone and the second portion is a base of the camera phone.

7. The camera phone of claim 1, wherein the camera phone further comprise at least one display.

8. The camera phone of claim 6, wherein at least one among a main display on the flip portion and an auxiliary display on an opposing side of the flip portion enables viewing without the lens when the camera phone is in an open position and the auxiliary display enables viewing with the lens when the camera phone is in a closed position.

9. The camera phone of claim 1, wherein a lens exit pupil is larger than a camera entrance pupil to allow for tolerance.

10. A communication device in a clam shaped housing, comprising:
a camera incorporated within a first portion of the clam-shaped housing of the communication device; and
a lens incorporated within a second portion of the clam-shaped housing of the communication device, wherein the camera and the lens substantially align when the first portion pivots relative to the second portion.

11. The communication device of claim 10, wherein the lens is an afocal converter lens that changes an effective focal length of a lens of the camera from among a wide angle lens, a telephoto lens, and a macro lens, according to the afocal converter lens selected.

12. The communication device of claim 10, wherein the first portion is a base of the communication device and the second portion is a flip portion of the communication device.

13. The communication device of claim 10, wherein the first portion is a flip portion of the camera phone and the second portion is a base of the camera phone.

14. The communication device of claim 10, wherein the first portion of the communication device further comprises a keypad and the second portion comprises at least one display.

15. The communication device of claim 10, wherein the communication device further comprises at least one display.

16. The communication device of claim 15, wherein at least one among a main display on a flip portion of the communication device and an auxiliary display on an opposing side of the flip portion enables viewing without the lens when the communication device is an open position and the auxiliary display enables viewing with the lens when the communication device is in a closed position.

17. The communication device of claim 10, wherein a lens exit pupil is larger than a camera entrance pupil to allow for tolerance.

18. A method of incorporating an attachment lens to a camera in a camera phone in a flip style housing, comprising the steps of:
incorporating the camera within a first portion of the flip style housing; and
incorporating the attachment lens within a second portion of the flip style housing; and
selectively aligning the camera with the attachment lens when the first portion pivots relative to the second portion.

19. The method of claim 18, wherein the attachment lens is selected among a wide angle lens, a telephoto lens, a macro lens, and a filter.

20. The method of claim 18, wherein the camera phone further comprises at least one display and the method further comprises the step of viewing an image on at least one among a main display on a flip portion of the camera phone and an auxiliary display on an opposing side of the flip portion when the phone is in an open position and viewing another image using the attachment lens on the auxiliary display when the camera phone is in a closed position.
